(19) United States
(12) Patent Application Publication
(10) Pub. No.: US 2015/0040437 A1
(43) Pub. Date: Feb. 12, 2015

(54) EASY-ON TALKING AND DETECTION SHOES FOR KIDS

(71) Applicant: Joseph Ibetoh, Lanham, MD (US)

(72) Inventor: Joseph Ibetoh, Lanham, MD (US)

(21) Appl. No.: 13/961,143

(22) Filed: Aug. 7, 2013

(51) Int. Cl. G09B 19/00; A43B 3/30; G09B 5/04

(52) U.S. Cl. CPC G09B 19/0076; G09B 5/04; A43B 3/30
USPC 36/139; 434/319

(57) ABSTRACT

Disclosed embodiment relates to a talking shoe for kids. In a preferred embodiment, a communication apparatus is disposed with a detection device. In this embodiment, the detection device comprise of nano sensors embedded in silicon substrate disposed in micro/nano-fibers.

This Application claims priority from application Ser. No. 12/228,408 filed Aug. 13, 2008

### FIELD OF INVENTION

The present invention generally relates to a pressure sensing device configured with at least a sensor means which is communicatively connected to a speaker means.

### BACKGROUND OF THE INVENTION:

Children shoes with good play value does not allow variation and flexibility in identifying the proper foot to be identified by kids, as well as providing freedom for imagination and creativity. Interactivity, that is, the ability of properly selecting the correct shoe “Left vs right” to respond to a user's action by self trial in which if wrongly mixed, a signal is emitted and an effect is enabled. Sound effects have been used during play activity for many years, the sounds assisting the child to engage in imaginary activity or play. Children commonly act a role in the context of physical activity, and sound is ideally directly linked to this physical activity. Examples of shoes with sound effects are not in the art. Lights have also been linked to play activity. Examples are light-sabers, glow-in-the-dark stars or necklaces, and hand held flashlights used to play light tag or lighting shoes, but non seems to communicate the proper activity for a kid to rightly wear a shoe correctly.

### SUMMARY OF THE INVENTION

The present invention provides shoes normally warn by kids so that these kids would be able to identify the proper sides and sizes of their shoes. A remote control is configured with the detection platform so that parents can identify the locations of their kids. A receiver and a transmitter is configured with the detection platform and the remote control to enable a communication environment for the detections. The detection platform comprises nano-sensors configured for detection sensitivity.

### BRIEF DESCRIPTION OF THE DRAWINGS

FIG. 1a depicts a shoe showing various sensors of the present invention

FIG. 1b depicts a sensory circuitry of the shoe for the present invention

FIG. 2 depicts the right interior soul of the shoe for the present invention

FIG. 3 depicts the left interior soul of the shoe for the present invention

FIG. 4 depicts the right exterior soul of the shoe for the present invention

FIG. 5 depicts the left exterior soul of the shoe for the present invention

FIG. 6 depicts a remote control device for the shoe for the present invention

### DETAILED DESCRIPTION OF THE INVENTION

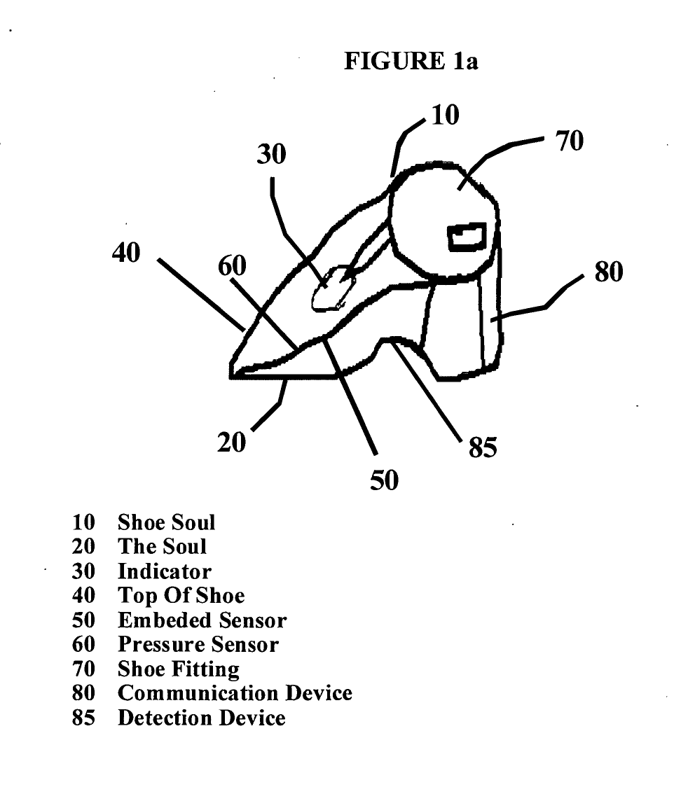

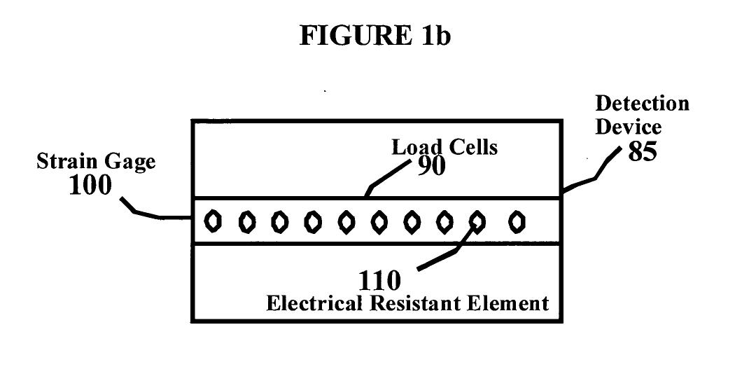

FIG. 1a depicts a shoe 10 with embedded sensors 50 configured with a communication device, comprising at least an RFID chip 80, an indicator 30, pressure sensor 60, and a detection device 85. At least a top shoe 40 is seen, in association with the shoe fitting 70. Referring to FIG. 1b is seen the sensory circuitry of FIG. 1a disposed with a soul 20, of the shoe 10, comprises at least a detection device 85 comprising of at least a load cell 90 configured with at a strain gage 100. The strain gage 100 comprising electrical resistance elements 110. The load cells 90 responsive for sensing pressure from at least a person 200 wearing shoe 10. When person 200 attempts to wear shoe 10, at least a pressure is sensed by the pressure sensor 60, and communication is enabled by the communication device 80.

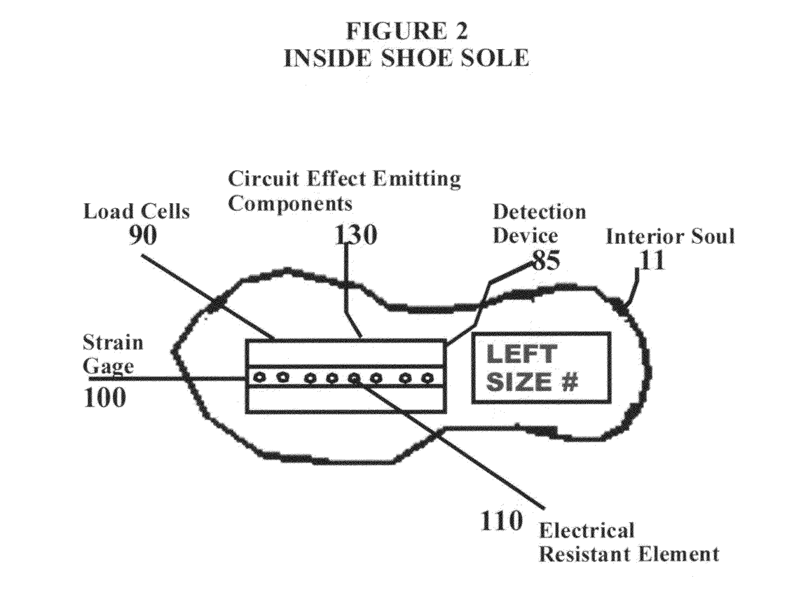

FIG. 2. Depicts the interior soul 11 of the right side of shoe 10, comprising the load cell 90, the strain gage 100, and the electrical resistance elements 110.

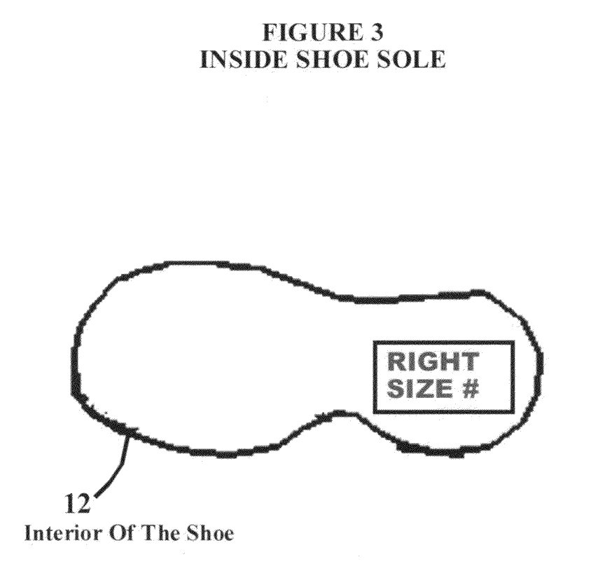

FIG. 3 depicts the interior 12 of the left side of shoe 10, configured with the load cell 90, the strain gage 100, and the electrical resistance element 110

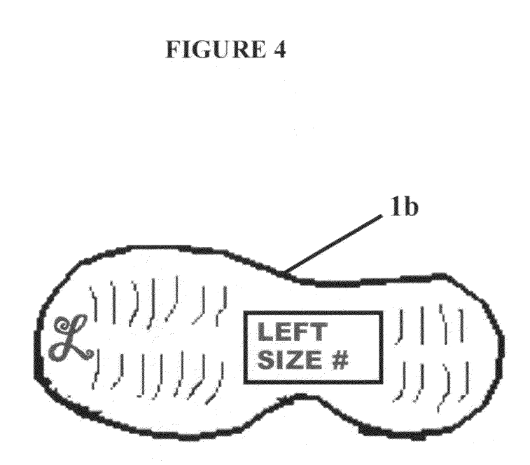

FIG. 4 depicts the external soul 13 of the right side of shoe 10, configured with a communication device 80 to enable kids to identify the right side of shoe 10. The communication device 80 is communicatively configured with an indicator 30, responsive for enabling kids identifying the size of the shoe 10, and the communication device 80 enables kids identify the proper side of the shoe 10 by communicating in human voice auditory the specific size and side of the shoe.

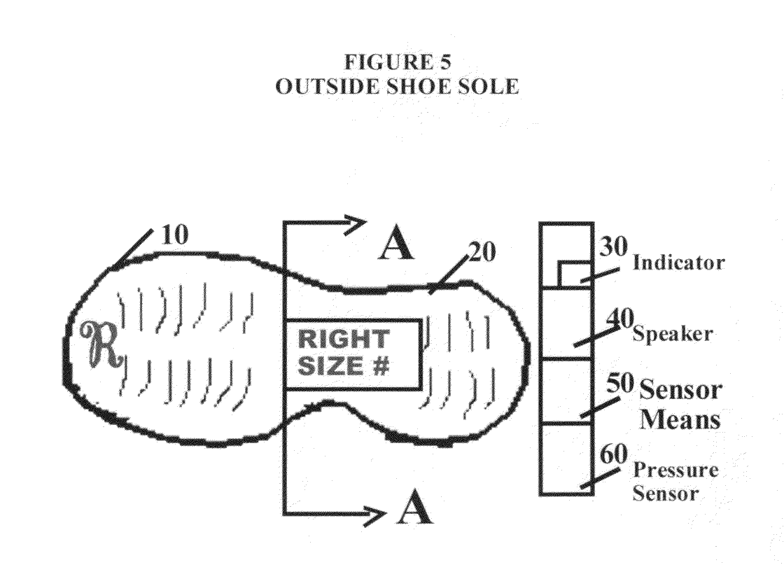

FIG. 5 depicts a sectional view AA, comprising the external soul 12 of the left side of shoed, 10, configured with a communication device 80 to enable kids to identify the right side of shoe 10. The communication device 80 is communicatively configured with an indicator 30, responsive for enabling kids identifying the size of the shoe 10, and the communication device 80 enables kids identify the proper side of the shoe 10 enable by broadcasting in human voice auditory the proper response that is required to enable kids to properly be responsive to wearing their shoes properly by themselves. The shoe is disposed with embedded sensors 50 and pressure sensors 60. At list a speaker 40 is affixed with the shoe. The invention further depicts, in one embodiment, a remote control 120 configured with the communication device 80. In other embodiment, the remote control 120 is responsive for monitoring the location of the kid wearing shoe 10, such that shoe 10 is communicated to by the remote control 120 and at least a response is further enabled when said kid is identified. The embedded shoe effect emitting communication device 80 further converts pressure positions and dynamic movements into effective communications, such as left or right foot; wrong foot, good boy or good girl emission when the kid successfully puts on the shoe rightly.

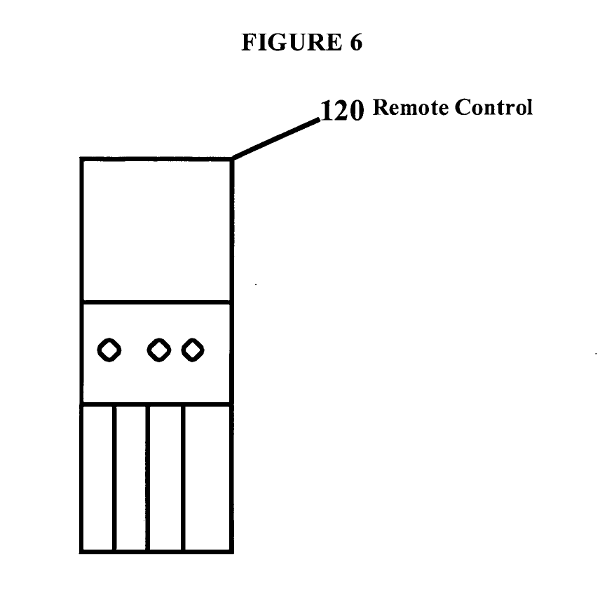

FIG. 6 depicts a controller 120. In a preferred embodiment of the invention, the detection device 85 comprises a circuit effect emitting components 130, and power supply coming off the electrical resistance elements 110 consisting of miniaturized elements with light weight and compactness which are desirable. The circuitry, for example, can be produced on a printed circuit board. Alternatively, part of the circuit can be miniaturized on an integrated circuit (IC) chip 140. The speaker may also be miniaturized. Such speakers are available commercially.

What is claimed:

1. A shoe device disposed with a human voice auditory communication device: comprising; at least a sensor means disposed with at least an electrical resistance element; at least a communication means; said sensor means embedded in at least a silicon substrate and etched/fused in a microfiber material to enable an effective detection means; at least a voice auditory apparatus is disposed with said detection means; at least a wireless control device in communication with said sensor means; at least a shoe is associated with said sensor means for monitoring at least a wearer of said shoe; and at least an emitting component is associated with said wireless control device for enabling communication with said detection means.

2. A shoe device for identifying sides and size as claimed in 1, wherein said sensor means operatively configured for detections.

3. A shoe device for identifying sides and size as claimed in 1, wherein said detection means communicatively connected to at least a said communication means.

4. A shoe device for identifying sides and size as claimed in 1, wherein said communication means being configured for broadcasting detections in human voice auditory.

5. A shoe device for identifying sides and size as claimed in 1, wherein said communication means further comprises at least a remote control device.

6. A shoe device for identifying sides and size as claimed in 5, wherein said remote control device being configured with said wearable outfit, wherein said detection means. responding to said remote control device for remotely identifying the location of at least a kid.

7. A shoe device for identifying sides and size as claimed in 6, wherein at least a voice auditory communication is enabled upon said detection.

8. A shoe device for identifying sides and size as claimed in 7, wherein said communication means further comprises human voice auditory.

9. A shoe device for identifying sides and size as claimed in 8, wherein said human voice auditory further configured for broadcasting specific operations and locations of said wearable outfits.

10. A shoe device for identifying sides and size as claimed in 9, wherein said specific location comprises identifying the presence of said shoe.

11. A shoe device for identifying sides and size as claimed in 10, wherein said detection means further comprises at least a talking shoe for kid.

12. A shoe device for identifying sides and size as claimed in 11, wherein said wearable outfit further comprises means for training kids to identify the proper foot to be inserted into said shoe.

13. A shoe device for identifying sides and size as claimed in 12, wherein said shoe further comprises means for training kids further, comprising at least a response that is broadcast from said voice auditory apparatus; wherein said response including at least one of: left and/or right, responsive to at least pressure being sensed upon insertion of at least a foot into said shoe for identifying the proper foot to be inserted into said shoe.

14. A shoe device for identifying sides and size as claimed in 1, wherein of said detection means further comprises at least a platform operatively configured with said remote control device.

15. A shoe device for identifying sides and size as claimed in 14, wherein said remote control device further comprises at least a transmitter means.

16. A shoe device for identifying sides and size as claimed in 15, wherein said remote control device further comprises at least a receiver means.

17. A shoe device for identifying sides and size as claimed in 1, wherein said detection means further comprises at least a nano-sensor applications configured with at least a receiver means.

18. A shoe device for identifying sides and size as claimed in 17, wherein said detection means further comprises at least a sensor configured with at least a transmitter means.

19. A shoe device for identifying sides and size as claimed in 18, wherein said sensor means further comprises at least a load cell configured with at least a train strain gage.

20. A communication device for identifying sides and size as claimed in 1, wherein said sensor means further comprises at least a detection apparatus.
